(19) United States
(12) Patent Application Publication
(10) Pub. No.: US 2003/0004864 A1
(43) Pub. Date: Jan. 2, 2003

(54) Receivables management method

(76) Inventors: Anthony John Kregor, Seaford (AU); Kenneth John Picken, Hawthorn East (AU); David Laurence Stagg, Kew (AU)

Correspondence Address: BIRCH STEWART KOLASCH & BIRCH, PO BOX 747, FALLS CHURCH, VA, 22040-0747, US

(21) Appl. No.: 09/892,725

(22) Filed: Jun. 28, 2001

(51) Int. Cl. G06F 17/60

(52) U.S. Cl. 705/38

(57) ABSTRACT

A receivables management method whereby a credit provider provides sufficient credit to a plurality of buyers who place orders with a seller to cover debts incurred only when placing the orders with the seller. The buyers placing the orders with the seller thereby incurred debt with the seller. The seller fulfills the orders and transfers the debt to the credit provider in exchange for settlement of the debts by the credit provider. The credit provider seeks settlement of the debts from the buyers. In addition, an apparatus is provided for processing data wherein data is received from a seller relating to orders made by a plurality of buyers. The data includes order information and debt information. A data processing device is provided for separating the order information from the debt information and forwarding the debt information to the debt processing device. The debt processing device processes the debt information to produce processed debt information before returning the processed debt information to the data processing device. The data processing device associates the order information with the processed debt information to produce processed data to be sent to the buyers.

### FIELD OF THE INVENTION

The present invention relates to a receivables management method and apparatus for processing data.

### BACKGROUND OF THE INVENTION

Funding trade debts (receivables) forms a large part of the working capital of all major companies. That is, once an order is placed with a company and a sale is recorded, although the value of the sale becomes an asset of the company, the company may need to wait a considerable period of time before they receive settlement of the debt incurred as a result of the placed order. It is thus necessary for the selling company to have capital to cover the cash which they have not received. Delays in receiving settlement of debt may cause cash flow problems for the selling company which may in turn, cause delays in settling debts they have with their own creditors.

A study conducted in Australia indicated that in the period from December 1999 to November 2000, the average payment period was 68 days past the due date. Further, the University of Tennessee study undertaken in relation to B2B payments, the participating companies reported that approximately 61% of their accounts receivable were 50 days or older.

Accordingly, it would be advantageous to provide an alternative receivables management method. Further, it would be desirable that any such receivables management method reduced the cost of transactions to the seller.

Currently, a selling company typically has an electronic trading facility provided by their bank. This may be an EFTPOS terminal but could also be an internet banking portal. An additional transaction cost may be incurred where the buyer uses a different bank to the seller. In this case, the seller's bank will typically charge a fee (usually referred to as an interchange fee,) for carrying out the transaction. That is, the fee is charged in return for the seller's bank retrieving the money represented by the transaction from the buyer's bank. Typically, an interchange fee is charged as a percentage of the transaction (say 2%) and this interchange fee is split between the seller's bank and the buyer's bank—for example, 0.8% to the seller's bank and 1.2% to the buyer's bank. It would be desirable to reduce these fees.

### DISCLOSURE OF THE INVENTION

Accordingly, the invention provides a receivables management method comprising:

(a) a credit provider providing sufficient credit to a plurality of buyers who place orders with a seller to cover debts incurred only when placing said orders with said seller;.

(b) said buyers placing orders with said seller thereby incurring debts with said seller;

(c) said seller fulfilling said orders;

(d) said seller transferring said debts to said credit provider in exchange for settlement of said debts by said credit provider; and

(e) said credit provider seeking settlement of said debts from said buyers.

Preferably, settlement by said credit provider is performed automatically.

Preferably, said method further comprises assessing a risk of a proportion of the debt incurred by said buyers not being settled with said credit provider, and insuring against said risk.

It will be apparent that the credit provider will need to process the financial information generated by the seller as part of the transaction so that the credit provider can provide the buyer with an account. However, it would be undesirable for the credit provider to have to alter their existing systems in order to process this data, and therefore according to another aspect of the invention there is provided [insert claim 13].

### BRIEF DESCRIPTION OF THE DRAWINGS

A preferred embodiment of the invention will now be described in relation to the following drawings in which:

FIG. 1 is a schematic diagram illustrating the method of the present invention;

FIG. 2 is a schematic diagram illustrating the arrangement of the preferred embodiment;

FIG. 3 is a schematic diagram illustrating an embodiment in which the seller includes an intermediary and a plurality of ultimate sellers;

FIG. 4 illustrates a further alternative where there are a plurality of credit providers; and

FIG. 5 shows further detail of the scheme administrator of FIGS. 2 to 4.

### DESCRIPTION OF THE PREFERRED EMBODIMENTS

It will be appreciated that when a company receives orders for products or services from a buyer of those products or services, a debt is incurred by the buyer with the seller. In some circumstances the seller will not supply to the buyer until they have received settlement of the debt, however, in many circumstances it is necessary for the seller to extend credit to all of its buyers in order for those buyers to conduct business with the seller. The seller will often supply the goods or services ordered by the buyer before receiving payment for those goods or services from the buyer. Thus, it is necessary for any seller to have a certain amount of working capital to carry out their business so that they can pay their own suppliers and their ongoing business costs while waiting to receive funds from buyers. This imposes a substantial cost on businesses.

In the preferred embodiment, the burden of providing credit to buyers is shifted from the seller to a credit provider.

In the preferred embodiment, this is achieved by the credit provider providing credit to the buyers of the seller for the specific purpose of buying from the seller. An immediate effect of doing so is to reduce transaction costs. For example, if the seller has an account with the first bank (or credit provider), it can be assumed that some of the buyers who purchase from the seller will have accounts with other banks (credit providers).

It a buyer who has a different credit provider to the seller places an order with the seller and pays for that order electronically via an electronic payment facility provided by the seller's credit provider a fee will be charged to the seller on the transaction. Such fees, typically known in the industry as interchange fees, are usually about 2% of the transaction and are, charged for the purpose of covering the costs of the sellers credit provider redeeming money from the buyer's credit provider. The interchange fee is typically split between the seller's credit provider and the buyer's credit provider in the ratio of 0.8% to 1.2% or 1.0% to 1.0% depending on the nature of the transaction. In the method of the present invention because all of the participating buyers of the seller are provided with credit from the same credit provider, transaction fees are greatly reduced. However, more importantly the burden of providing credit is shifted from the seller to the credit provider.

It will be appreciated that shifting the burden of providing credit also involves shifting the risk of buyers defaulting on their debts from the seller to the credit provider.

This poses a number of difficulties because of the normal method of assessing credit to be provided. For example, a credit provider when providing credit to a person, normally needs to assess the risk of each person, for whom they provide credit, defaulting on their debt and also needs to assess their prospects of recovering such debts should the person default. If the level of credit being provided is substantial, the credit provider is likely to seek guarantees from the persons involved. For a seller, the proposition of all of their buyers having to undergo credit check by the credit provider is an unattractive one. A seller would be concerned that asking their clients to participate in credit checks would encourage their buyers to go elsewhere to obtain the goods or services.

The inventors have realised that it is possible to address the risk of a proportion of the debt incurred by the buyers of a particular seller not being settled by insuring against the risk.

Therefore, in the preferred embodiment the credit provider takes out credit insurance to cover the unsecured credit provided to the buyers of the seller. This enables a much larger amount of unsecured credit to be provided than could be provided traditionally. Further, by assessing the credit risk as a whole, credit can be provided to most buyers of a particular seller without any specific credit assessment. It is only necessary to assess individual buyers if the demands for credit are unusual. For example, if the credit demands are outside of what is to be considered to be a normal credit requirement for the sellers business. In an experimental system installed with a major supplier to pharmacists in Australia, up to AU$350,000 of credit could be extended to any individual pharmacy without any check being made of the credit liability of the pharmacy provided the application for credit by the buyer did not also exceed 2.4 times the buyer's normal monthly spend with the seller. This enabled almost all pharmacies to be provided with credit without having their credit liability assessed individually. Thus, significantly reducing cost in connection with credit assessment while not imposing unnecessary on inconvenience to the sellers buyers.

It will be apparent to persons skilled in the art that the nature of the credit insurance provided and the level of insurance will depend on the nature of the seller's business and that the appropriate level of insurance can be assessed using standard actuarial procedures.

Typically, the insurer would initially look at the overall industry in which he seller is involved to determine the level of risk in that industry. This can be achieved by the insurer reviewing industry reports or reviewing their own databases in order to examine the track record of other persons engaged in business within the industry.

Then, the insurer would examine the seller's business, typically be reviewing their portfolio of debtors (i.e. buyers) to determine a level of bad debts etc. The insurer may investigate to determine whether these past problems are likely to continue. The insurer will then set up a number of criteria which must be met in order for credit to be provided to individual buyers. If criteria aren't met the applications for credit are reviewed individually and credit is provided or refused. If credit is refused, the seller may choose to ask the credit provider to provide credit to a buyer anyhow in exchange for a guarantee to buy back any bad debt incurred by that buyer from the credit provider.

In the foregoing description, the cost of insuring the credit is borne by the credit provider but this is paid for by a management fee which is paid by the seller to the credit provider, usually, as a percentage of turnover. In an alternative embodiment, the seller may carry the burden of the credit insurance in exchange for a reduced management fee.

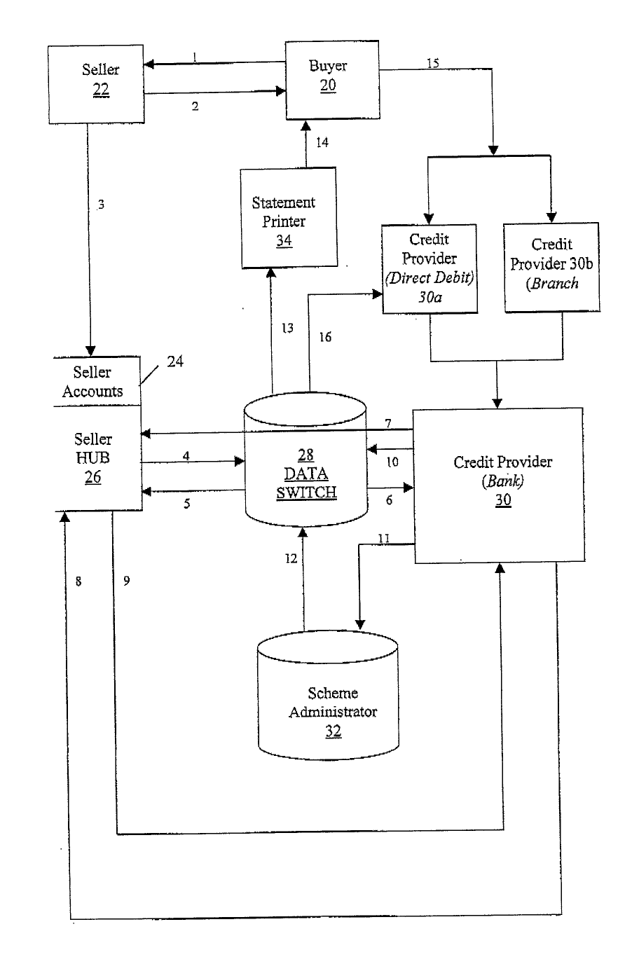

FIG. 1 illustrates a process which occurs after credit has been provided by the credit provider to the buyers 20 of a seller 22. FIG. 1 illustrates the process for a single buyer 20. As indicated by arrow 1, the buyer places an order with seller 22. Arrow 2 indicates that the seller then fulfils the order. It will be appreciated that order fulfilment need not be synchronous with the remaining steps. That is, order fulfilment will occur in accordance with the seller's normal business practices. For example, the seller is a paint shop the supply may be made immediately, however, if the seller is a computer hardware provider, it may be necessary to assemble the relevant computer hardware before supplying the computer hardware. Details of the order of the buyer and hence the debt incurred by the buyer are entered into the seller's account system 24 as indicated by arrow. At the end of each day, the seller's system 24 batches all invoiced transactions and forward the data from seller hub 26 to the data switch 28 as indicated by arrow 4. It will be thus appreciated that the data transferred from the sellers hub 26 includes both financial and non-financial information, herein termed debt information and order information respectively. The respective items of information are marked as relating to buyer 20.

As indicated by arrow 5, the data switch 28 acknowledges receipt of this information to the sellers hub 26. The data switch 28 then separates the financial (debt) and non-financial (order) information and transmits the financial information to the credit provider 30 as indicated by arrow 6 together with a unique key which identifies the buyer. The credit provider 30 analyses the financial data provided by data switch 28 and produces an exception report 7 for any non-matching account numbers which can be reprocessed by seller 22. The credit provider 30 then automatically credits the seller's hub 26 with the total value of all debts of the previous day as indicated by arrow 8.

Each month the seller transmits a receivables management fee to the credit provider 30 as indicated by arrow 9. This receivables management fee is split between the credit provider 30 and a scheme administrator 32. The scheme administrator is responsible for maintaining data switch 28 as well as carrying out a number of other functions which will be described in more detail below. As indicated by arrow 10, at the end of each month, the processed financial information is forwarded to the data switch 28. The processed financial information includes what is essentially an account for each buyer 20 and is tagged by the buyer's individual key or account number. At the same time, data is transmitted by data switch 28 to the scheme administrator 32 as indicated by arrow 11. This data includes the processed financial information and may also include additional demographic information. In the preferred embodiment, the scheme administrator uses the processed financial information to generate loyalty program rewards points for each of the buyers and transmits data representative of the awarded points as indicated by arrow 12 to the data switch 28.

The data switch then assembles the non-financial (order) information, the financial debt information and the rewards scheme information into a single file. Thus, this file contains all the normal monthly account such as the buyer could expect to receive from a seller with full details of all orders made from the seller during the proceeding months a summary of previous payment and some of the outstanding balance. However, this information is enhanced with the rewards scheme data and the details of how to pay the credit provider.

In the preferred embodiment, files representing this data are then transferred to a statement printer 34 as indicated by arrow 13. The statement printer then prints this data from these data files onto the appropriate stationary and they are dispatched as indicated by arrow 14 to the buyer 20.

It will be appreciated by those skilled in the art that the statements could also be transmitted electronically to the buyer 20.

The statement includes the deadline for the buyer to pay the statement. Typically credit providers use a 55 day billing cycle and hence the buyer will typically have 25 days to settle their debts with the credit provider. Thus, it will be appreciated that it is the credit provider 30 who is seeking settlement of the debts rather than the seller 22. As illustrated by arrow 15, the buyer 20 can either settle directly with the credit provider 30 by direct debit mechanism 30a as indicated by arrow 15 or can settle by attending a branch of the credit provider 30b as indicated by arrow 15b.

While the foregoing embodiment has been described in relation to a monthly billing cycle, it will be appreciated that the billing cycle can be varied depending on the needs of the seller and the credit provider.

The use of a loyalty program is adopted in the present invention because it will be appreciated that the credit provider 30 is likely to have stricter credit enforcement than a seller 22. Hence, providing a loyalty awards scheme offsets the fact that the buyer may have a reduced period in-which to pay their invoices.

Above it is described that the loyalty program rewards points are awarded on the basis of financial transactions. However, it will be appreciated by persons skilled in the art that points may also be awarded on the basis of the purchase of particular products whereby the seller can encourage, for example, the purchase of a new product or a product where sales have dropped. In this case, some or all of the non-financial information can be forwarded to scheme administrator 32 so that this information can be used when assessing the appropriate level of reward points to be awarded.

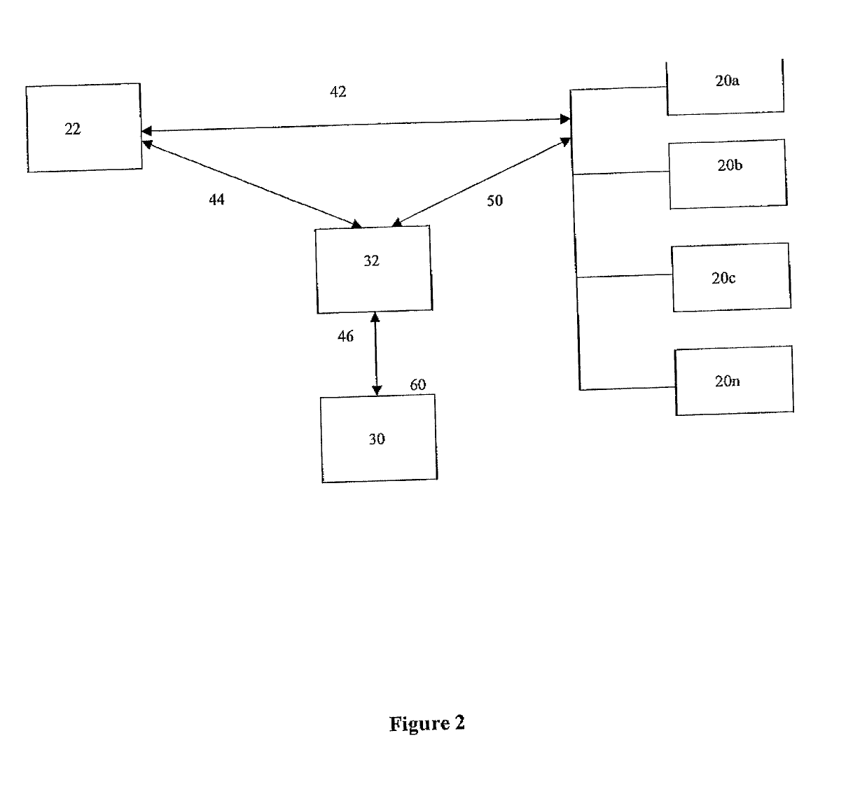

FIGS. 2 to 4 illustrate various possible configurations in which the preferred embodiment can be employed. For the sake of simplicity, in these diagrams the data switch 28 and the scheme administrator 32 and the statement printer 34 are shown collectively as scheme administrator 32.

FIG. 2 reflects the situation of FIG. 1 where a plurality of buyers 20a to 20n place orders and receive fulfilment of the orders as indicated by arrow 42 from a seller 22. The seller communicates all transaction data including debt and order information to a scheme administrator 32 as indicated by arrow 44. Financial information is passed between the scheme administrator 32 and a credit provider 30 as indicated by arrow 46. Account information is passed by the scheme administrator to buyers 20a to 20n as indicated by arrow 50.

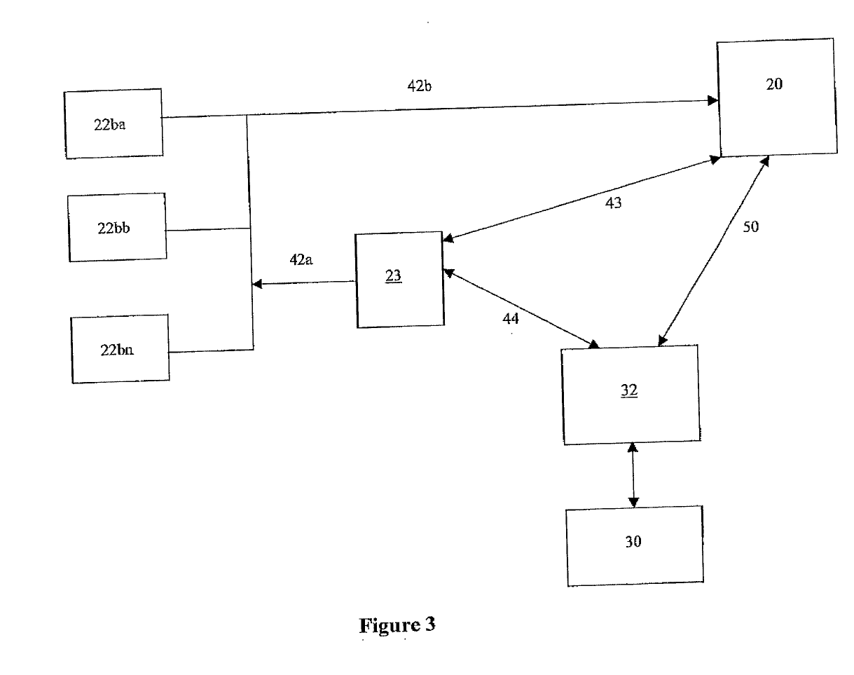

FIG. 3 illustrates an alternative arrangement wherein there are a plurality of sellers 22, 22a to 22n. In this embodiment, orders are placed with the ultimate seller through intermediary 23 as indicated by arrows 43 and 42a, while order fulfilment occurs directly from ultimate sellers 22a to 22n to buyer 20 as indicated by arrow 42b. Each of the sellers have credit provided by the same credit provider to their buyers. Thus, it will be appreciated that intermediary 23 could represent a B2B hub. Each buyer does not necessarily have credit provided for the purpose of purchasing goods or services from each seller, or may have reached their credit limit for an individual seller, hence the B2B hub preferably has access to the credit information for each buyer so that when the buyer makes an offer to purchase goods and services, and the sellers make offers to fulfil that offer, the B2B hub 23 will only complete transactions where the buyer currently has credit to purchase from the seller.

Hence, the buyer may not get the cheapest price if they, for example only have sufficient credit with the most expensive seller 22. In all other respects, the system operates as indicated above but it will be appreciated that transaction data is passed from intermediary 23 to scheme administrator 32 as indicated by arrow 44. It will be appreciated that the arrangement of FIG. 3 can be varied so that while orders are placed through intermediary 23, the transaction data is generated by respective sellers 22 and passed to the scheme administrator 32. It will be appreciated that the buyer may be provided with an overall amount of credit by a single credit provider but that credit will be limited in its application—i.e. only a proportion of the overall credit will be useable with an individual seller.

It will be further appreciated that settlement from the credit provider 30 can either occur through the intermediary 23 or directly to respective sellers 22.

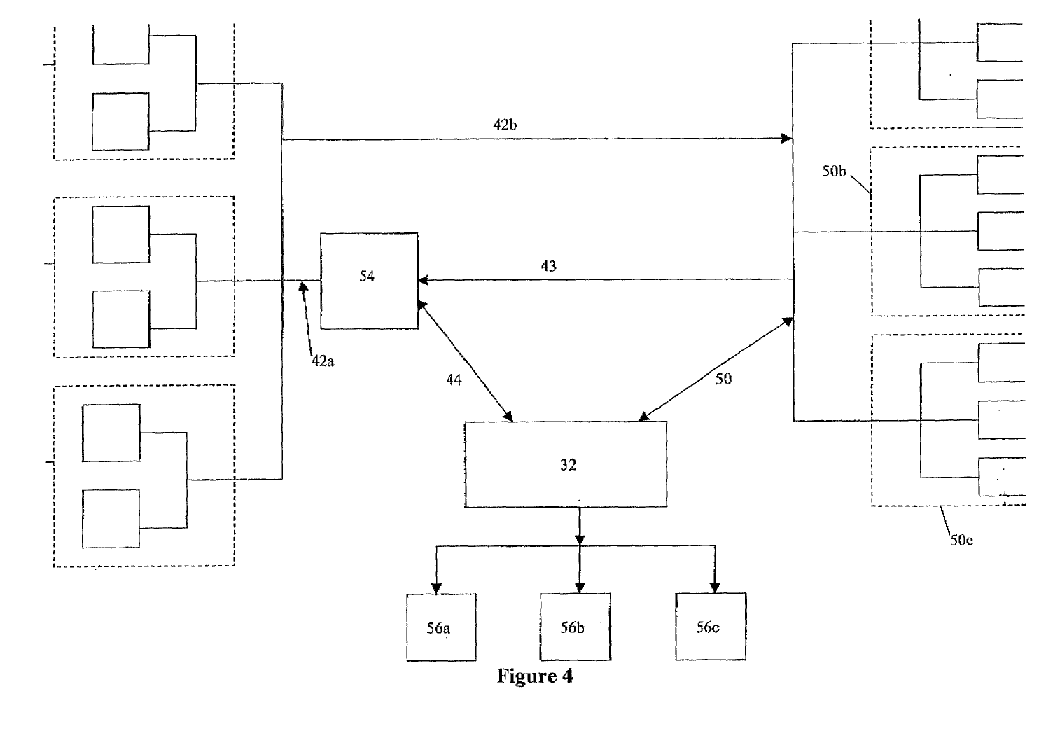

FIG. 4 illustrates a more complicated environment in which there are a plurality of credit providers 56a, 56b and 56c. In this embodiment, while buyers 50 place orders through an intermediary 54, in the form of B2B portal, the buyers 50 and sellers 52 are grouped by particular credit providers. For example, seller group 52a receives orders from buyer group 50a who use credit provided by credit provider 56a. In other respects, the system operates as described above. However, it will be appreciated that an individual buyer could have credit provided by more than two credit providers but in each case, the credit is provided solely for purchase with a particular seller.

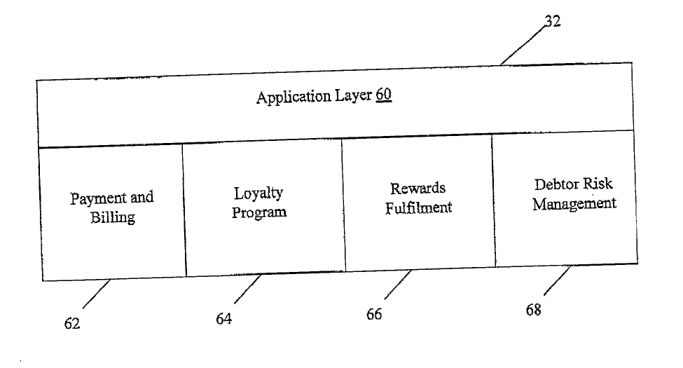

FIG. 5, shows a detailed view of the credit provider 32 of FIGS. 2 to 4. The credit provider consists of an application layer which provides an interface with the other elements of the system. A payment and billing gateway, receives all data from the seller 22 and transmits the financial data to the credit provider 30. The payment and billing gateway 62 can also act as a gateway for payments between the seller and the credit and the credit provider as well as between the buyers and the credit provider.

Loyalty program 64 communicates with payment and billing module to generate relevant reward points and is in itself in communication with the reward fulfilment section which allows buyers to redeem their points.

The system administrator also includes a debtor risk management interface for dealing with the insurer.

It will be appreciated that as part of the foregoing described invention, it has been necessary to develop apparatus for processing data. Most credit providers operate on so called legacy systems which while capable of processing financial data are not configured to handle non financial data. Therefore, in the preferred embodiment the data switch 28 of FIG. 1 is used as a data processing means to separate the order information from the debt information and forward the debt information to the debt processing means of the credit provider. The data processing means is further configured to reassemble the order information with the process debt information in order to produce processed data to be sent to the buyers. Further, in the preferred embodiment, the data processing means also associates the additional information (such as rewards scheme information) generated from at least one of the debt information and the order information with the processed data forwarded to the buyer. Thus, the credit provider does not need to overly adapt their existing systems in order to operate the foregoing scheme.

It will be apparent to persons skilled in the art that various modifications may be made to the present invention and that the scope of the invention is to be determined solely from the scope of the following claims.

What is claimed is:

1. A receivables management method comprising:
(a) a credit provider providing sufficient credit to a plurality of buyers who place orders with a seller with to cover debts incurred only when placing said orders with said seller;
(b) said buyers plating orders with said seller thereby incurring debts with said seller;
(c) said seller fulfilling said orders;
(d) said seller transferring said debts to said credit provider in exchange for settlement of said debts by said credit provider; and
(e) said credit provider seeking settlement of said debts from said buyers.

2. A method as claimed in claim 1 wherein settlement by said credit provider is performed automatically.

3. A method as claimed in claim 1, wherein said method further comprises assessing a risk of a proportion of the debt incurred by said buyers not being settled with said credit provider, and insuring against said risk.

4. A method as claimed in claim 3, wherein insuring against said risk is performed by said credit provider.

5. A method as claimed in claim 3, wherein insuring against said risk is performed by said seller.

6. A method as claimed in claim 1, wherein said orders are placed with said seller through an intermediary.

7. A method as claimed in claim 6, wherein said there are a plurality of ultimate sellers, and said intermediary controls which of the sellers said buyer's order is placed with so that said order is only placed if said buyer has sufficient credit with said seller.

9. A method as claimed in claim 1, wherein said debt is transferred as a debt information together with order information identifying said orders whereby order information can be provided to each buyer when said credit provider seeks settlement of said debt.

9. A method as claimed in claim 8, wherein said method involves said credit provider processing said debt information, and wherein order information is separated from said debt before said debt information is processed by said credit provider, and said order information is subsequently associated with the processed debt information.

10. A method as claimed in claim 8, wherein said subsequent association with said processed debt information involves association with additional information generated from at least one of said debt information and said order information.

11. A method as claimed in claim 10, wherein said additional information includes loyalty program information.

12. Apparatus for processing data comprising:
(a) data receiving means for receiving data from a seller relating to orders made by a plurality of buyers, said data including order information and debt information;
(b) data processing means for separating said order information from said debt information and forwarding said debt information to debt processing means;
(c) debt processing means for processing said debt information to produce processed debt information before returning said processed debt information to said data processing means, whereafter said data processing means associates said order information with said processed debt information to produce processed data to be sent to said buyers.

13. Apparatus as claimed in claim 12, wherein said data processing means associates additional information with said debt information to produce said processed data, wherein said additional information is generated from at least one of said debt information and said order information.

14. Apparatus as claimed in claim 13, wherein said additional information is loyalty program information.
